(19) United States
(12) Patent Application Publication
(10) Pub. No.: US 2016/0201356 A1
(43) Pub. Date: Jul. 14, 2016

(54) TAMPER RESISTANT PADLOCKS

(71) Applicant: David L. GEORGE, San Jose, CA (US)

(72) Inventor: David L. George, San Jose, CA (US)

(21) Appl. No.: 14/914,470

(22) PCT Filed: Aug. 26, 2014
(86) PCT No.: PCT/US2014/052748

§ 371 Date: Feb. 25, 2016

Related U.S. Application Data
(60) Provisional application No. 61/870,127, filed on Aug. 26, 2013.
(60) Provisional application No. 62/018,195, filed on Jun. 27, 2014.

(51) Int. Cl. E05B 27/00; E05B 67/02

(52) U.S. Cl. CPC E05B 27/0057; E05B 67/02

(57) ABSTRACT

Padlock structures in the form of a trailer lock (10) and base and shackle padlocks (124, 168) are provided. Each type of padlock includes a lock body/base (12, 126, 168) and a lock pin (42) or shackle (128). At least the lock body (12) and/or base (126, 158) is a structural metallic material and each is provided with ceramic interior elements (22, 24, 112, 116, 120, 166, 174) to, in combination, defeat or severely hinder directional attacks by thieves' tools. In deluxe embodiments a cylinder guard structure (90, 152) with alternating metallic wafers (94, 98, 108) and ceramic wafers (96, 106) protects the lock cylinder (66). Deluxe metallic lock pins (42) and shackles (128) are also provides with interior ceramic plugs (22, 24) often with interior flexible cables or capillary tubes (26) with marking fluids (28) to mark and identify perpetrators of tampering.

This is a non-provisional application. Priority is claimed from U.S. 61/870,127 filed 26 Aug. 2013, U.S. 62/018,195 filed 27 Jun. 2014, and PCT/US2014/052748, all by the same current inventor.

### TECHNICAL FIELD

The present invention relates generally to security devices and structures and particularly for a method and protocols for layered mechanical structures which are extremely resistant to cutting, breaking and tampering by criminal elements.

### BACKGROUND ART

Physical security structures, in the nature of locks, padlocks and other structures used to prevent theft and vandalism are a necessary part of human life and business, given the fallibilities of the species. The ingenuity of malefactors is legendary in that methods of defeating security often improve and are developed at least as rapidly as the structures themselves. Therefore, it requires continuing improvement in the structures developed to protect treasures and assets.

Of course, it is almost axiomatic that nothing is foolproof, or in this case “burglar-proof”, so it often becomes a matter of trade-offs in cost, inconvenience for legitimate users, difficulty of defeat and the amount of time it takes to defeat any security structure. In this light, anything that makes it more difficult or tedious for the attacker to overcome the security structure can result in great benefits in the protections of lives and property.

Over the years, many improvements have been made in construction materials have improved the efficacy of locks, particularly padlocks, such as those used for securing doors, gates, lockers, chained vehicles, and the like. Improved alloys and the like have made it more difficult for thieves and the like to overcome them, but improved materials and sophistication in thieves' tools, such as rotary diamond cutters, laser cutters, hammer drills, and the like have kept pace. Consequently, a new method of approaching the problem is always desirable.

Accordingly, there is significant room for improvement and a need for better security structures, such as padlocks which provide a very high degree of resistance to cutting, breaking or otherwise disabling attacks.

### DISCLOSURE OF INVENTION

Accordingly, it is an object of the present invention to provide improved padlock-type structures utilizing interior ceramic components within metallic materials, the layered elements having different properties in order to thwart thieves and vandals.

Another object of the invention is to provide padlocks which prevent tampering by a great variety of thieves' implements and from many different angles.

A further object of the present invention is to provide a pattern of construction for security bar structures in order to provide padlocks which are adapted to hinder, slow and otherwise frustrate the improved tools and methods being used by malefactors.

Yet another object of the invention is to provide layered padlock-type structures for security elements which frustrate thermal cutting methods.

A further object of the present invention is to provide metallic and ceramic layers in padlocks, the components including layers for: structural integrity and hardness; abrasive cutting resistance; heat cutting resistance; heat, extreme cold and electromagnetic dissipation; and miscellaneous forms of attack.

Briefly, the preferred embodiments of the present invention are padlock structures all formed with common elements of a rigid, cut-resistant exterior layer and at least one interior layer formed of a ceramic material. The padlock structures each utilize successive layering or interposing materials with different physical and conductive properties to defeat attempts to penetrate, break, cut or melt the structures. The simplest embodiments include layering a ceramic material inside of a metallic structural material, and most also include an inner core of functional lock elements inside of the ceramic. More extensive embodiments involve multiple layering and intermittent layering of the metallic and ceramic materials. Deluxe embodiments include numerous ceramic components, strategically located, with multiple theft, breakage, and tamper defeating components to protect functional lock elements contained within the inner core.

An advantage of the present invention is that it provides padlock structures which are highly resistant to breakage, mechanical and laser cutting, melting, hammer drilling, cold-shattering, and other failure conditions.

Another advantage of the invention is that it provides for padlocks which impose significantly greater time and effort requirements in order to defeat the structures.

Yet another advantage of the present invention is that padlocks with ceramic layers utilizing discreet longitudinal segments (links or, in some instances, “fish”), particularly when spring loaded, result in lower potential for catastrophic crushing or breaking and significantly easier assembly as opposed to continuous rods or tubes.

A further advantage of the present invention is that it takes advantage of significant developments in the creation and cost-effectiveness of ceramic materials which may be incorporated into security bars.

Yet another advantage of the present invention is that it facilitates incorporation of an endless variety of functional components in the protected inner core of the padlock-like structures.

Another advantage is that the protocol of the present invention is that it utilizes divergent physical and thermal and electrical conductive or insulating properties of layered materials to protect against different methods of destructive attacks against the structures.

These and other objects and advantages of the present invention will become clear to those skilled in the art in view of the description of the best presently known mode of carrying out the invention and the industrial applicability of the preferred embodiments as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a vertical cross-section of the lock body of a trailer lock according to the invention, showing various elements in phantom to illustrate interior components;

FIG. 2 a is a cross sectional view of the lock body of FIG. 1, taken along lines 2-2;

FIG. 3 is a is a cross sectional view of the lock body of FIG. 1, taken along lines 3-3 and including additional components of the overall lock system;

FIG. 4 is an end view of a cam component for locking and unlocking the lock;

FIG. 5 is a cross-sectional view, similar to that of FIG. 3 and incorporating deluxe and enhanced structures and components, including a deluxe cylinder guard;

FIG. 6 is a partially cut-away key-end view of the enhanced embodiment of FIG. 5;

FIG. 7 is a front plan view of a shackle-type padlock, showing internal components in phantom;

FIG. 8 is a cross-sectional view, taken along lines 8-8 of FIG. 7, also illustrating some internal components in phantom;

FIG. 9 is a detail view of the interior components inside the lock body of the shackle-type padlock of FIGS. 7 and 8, detailing the operational components and a simple cylinder guard structure

FIG. 10 is a partially cut-away view of the arc portion of a lock shackle, showing an array of fish-spline ceramic lings in a bent structure; and

FIG. 11 is a (bottom or top) of an alternate lock body for a padlock.

### BEST MODE FOR CARRYING OUT THE INVENTION

The present invention is a set of related mechanical padlock structures which are highly resistant to disabling and tampering. The invention utilizes layering and nesting of divergent materials in order to thwart conventional methods used by thieves and vandals to disable or remove security barriers and fasteners from targets.

Examples of padlocks according to the invention are shown in the views of the drawing. Each embodiment is constructed according to the inventor's method and protocol, described in detail in the contemporaneous application entitle Layered Mechanical Structures for Security Applications (incorporated by reference herein) utilizing layers, whether continuous or intermittent, of divergent materials from the outside in, each layer having characteristics to counter/defeat typical techniques used by malefactors attempting to overcome the security aspects. Typically, the structures constructed according to the invention have a relatively hard structural outermost layer and one or more intermediate layers of a ceramic material, all protecting an inner core of operational elements, usually the mechanisms for locking and unlocking the padlock. The illustrated and potential embodiments include enhancements such as additional intermediate and intermittent layers and other potential modifications which are uniquely suited to the particular application. The basic protocol applies to all embodiments.

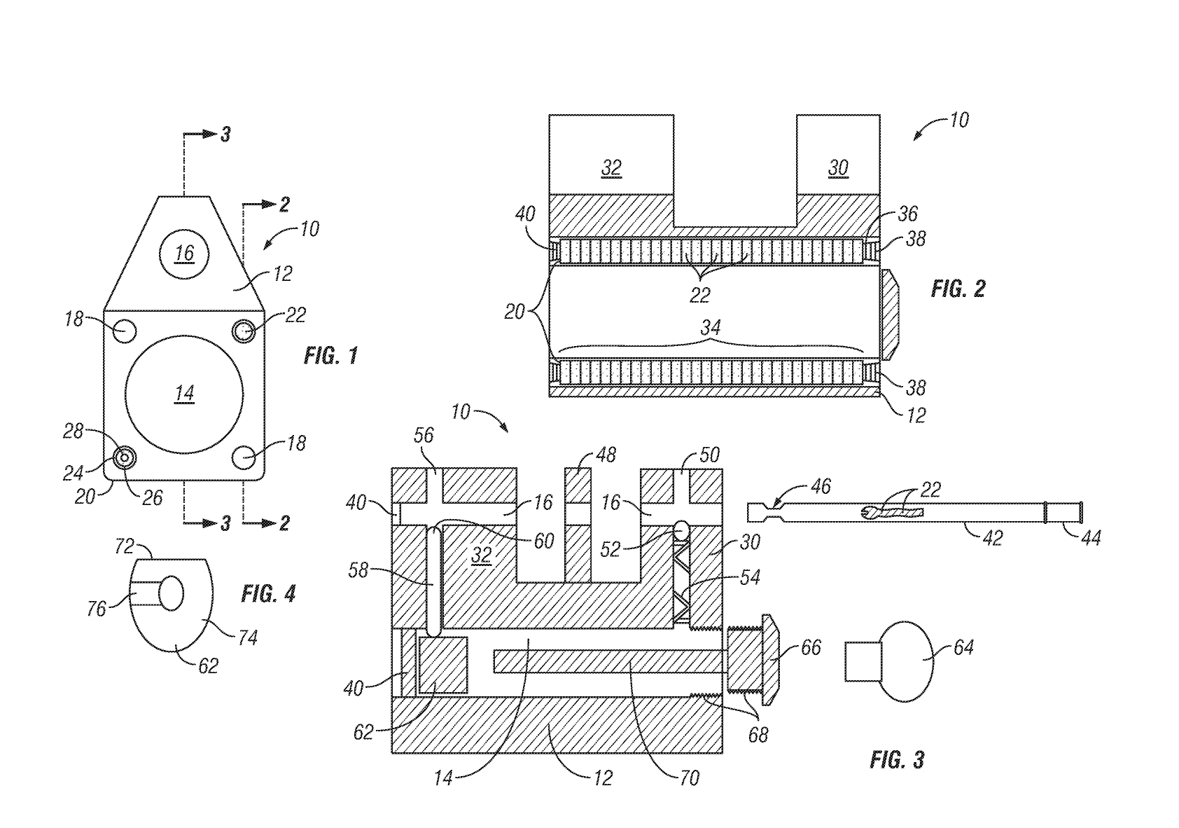

Referring now to FIGS. 1 through 6 the related embodiments indicated are all variants of a trailer lock 10 constructed according to the method and protocol of the present invention. The trailer lock 10 has a lock body 12 with a center bore 14 to contain internal elements. The same general structure of the lock body 12 applies to all of the structures shown in FIGS. 1-4, 5 and 6. The trailer lock 10 is adapted for use for restraining elements having a cable, chain or relatively thin structures about which the lock 10 may be fastened.

In this embodiment of the trailer lock 10 the lock body 12 is a metallic rectangular block having the center bore 14 extending longitudinally therethrough and a pin bore 16 parallel to and situated above the center bore 16. The lock body 12 is also longitudinally provided with corner bores 18 strategically placed to surround the components situated in the center bore 14. The lock body 12 of this embodiment is a structural metallic material such as steel, wrought iron, aluminum (which foils diamond cutters by fouling the disks) or the like and has a rectangular shape and rounded base corners 20 in its lower portion to particularly resist ring cutter attack. In higher security versions, the basic lock body may be provided with a case hardened outer layer.

The corner bores 20 are preferably filled with solid ceramic plug segments 22 or hollow ceramic tube segments 24. The ceramic further resists cutting and sawing and is particularly effective against ring cutting. The hollow tube segments 24 also provide an elongated interior cavity to retain elements such as interior flexible cable 25 or, as shown, a capillary tube 26 filled with a marking liquid 28 which can, upon breach, mark the perpetrator with an effectively indelible ink or scent. The use of discreet segments (22 and 24) results in greater flexibility in assembly and construction than solid continuous ceramic tubing. Since there is no requirement that the ceramic layer provide significant structural support or any continuity for conductance, it is feasible to use short links or “slugs” which can be aligned within the corner bores 18 (see FIG. 2).

The cross sectional view of FIG. 2 illustrates the vertical cross section taken through the center of two of the corner bores 20. This also shows the side view of the trailer lock 10 and shows that the upper extents of the lock body form an entry post 30 and a capture pose 32 separated by a central gap 33. This view also clearly shows how the ceramic plug segments 24 are contained within each corner bore 20. A compression spring 34 is provided at one (as shown) or both ends held in place by a drive screw 38 on the entry post 30 end and an end plug or cap 40 at the capture post 32 end (the orientation is optional and different types of closure may be used) The compression spring 34 applies compression force to the ceramic tube segments 24 such that, if one is crushed or broken by drilling, the adjacent segments 24 are urged to fill the gap and trap the drill bit, thus inhibiting further attack.

The enhanced trailer lock 10′, shown in cross section in FIG. 3, illustrates the interior of the lock 10′ and shows the additional elements necessary for the function. The securing element necessary to make the trailer lock 10′ work is an elongated lock pin 42 adapted to be inserted into the pin bore 16. The lock pin 42 is a specially shaped elongated cylinder which is radially symmetrical and includes a roughened grip 44 at one end and a detent ring 46 near the other end. The lock pin 42 is typically a case hardened metallic structure and, in the case of the particular lock pin 42 illustrated in FIG. 3, it is also provided with an interior layer of ceramic plug segments 22 to foil cutting efforts. To enhance security, the ceramic plug segments may be replaced by ceramic tube segments 24 including a flexible cable 25 or marking fluid 28.

An optional chain post 48 is also provided in the gap 33 intermediate the entry post 30 and the capture post 34. The chain post 48 is also pieced by the pin bore 16 such that the lock pin 42 slides therethrough. The chain post 48 allows the user to put a chain link completely on the chain post 48 below the pin bore 16 such that the chain is restrained form sliding. Further, the chain post 48 takes up space in the gap 33 and thus makes it more difficult for thieves' tools to work inside that zone.

A vertical bore in the form of a retention tube 50 extends through the entry post 30 to the central bore 14. This houses a ball bearing 52 resting on an expansion spring 54. This combination allows the ball bearing 52 to interact with the detent ring 46 of the lock pin 42 to prevent the lock pin from easily sliding completely out of the pin bore 16. Since the force restraining the pin is spring loaded the user can easily overcome it to slide the lock pin 42 in either direction.

A similar vertical bore in the form of a capture tube 56 pierces the capture post 32. In the zone intermediate the pin bore 16 and the center bore 14 the capture tube 56 contains a lock engagement rod 58 having a rounded knob 60. The rounded knob 60 engages the pin detent ring 46 to hold the lock pin 42 firmly in position when the trailer lock 10 is engaged in the locked mode (see FIG. 5). In some embodiments the lock engagement rod 58 and the rounded knob are replaced by a series of ball bearings 52 to serve the same purpose. It is noted that in use both the retention tube 50 and the capture tube 56 are ordinarily closed at the top end by a drive screw 38 or similar closure to prevent a vertical drill attack on the lock pin 42.

The bottom end of the lock engagement rod 58 engages the cam 62 which is situated in the center bore 14. The cam 62, illustrated in FIG. 4 is rotated in place when a key 64 engages a lock cylinder 66. The lock cylinder 66 in this embodiment is secured in lace within the center bore 14 by matching screw thread on both the lock cylinder 66 and the center bore 14. When the key 64 is turned the lock cylinder 66 then rotates a connector extension 70 which in turn rotates the cam 62. It is noted that, in some embodiments, the connector extension 70 is actually an integral continuation of the lock cylinder 66.

The cam 62 is illustrated in an end view in FIG. 4 where it may be seen that the cam 62 has a generally circular cross-section which includes a flattened arc 72 on one surface while the remainder of the exterior of the cam 62 is a full arc 74. A set screw 76 engages the connector extension 70 to cause the cam 62 to rotate in conjunction with the key 64. When the bottom of the lock engagement rod 58 engages the flattened arc 72 the lock engagement rod 58 is allowed to slide downward within the capture tube 56 such that the rounded knob 60 will no longer engage the pin detent ring 46 which releases the lock pin 42 so that it may slide outward until it is restrained by the ball bearing 52 in the retention tube 50 in an unlocked mode. This allows whatever is being held in place in the trailer lock 10 to be disengaged.

When the trailer lock 10 is desired to be placed in the locked mode an item (if desired) is placed such that the lock pin 42 traps the item either in the gap 33 between the lock pin 42 and the lock body 12 or else around the lock pin 42 itself. The lock pin 42 is then slid inward to the position that the pin detent ring 46 is aligned with the capture tube 56. At this point the key 64 is turned again such that the full arc 74 of the cam 62 forces the lock engagement rod 58 up so that the rounded knob engages the lock detent ring 46 to firmly hold the lock pin 42 in position and secure the item.

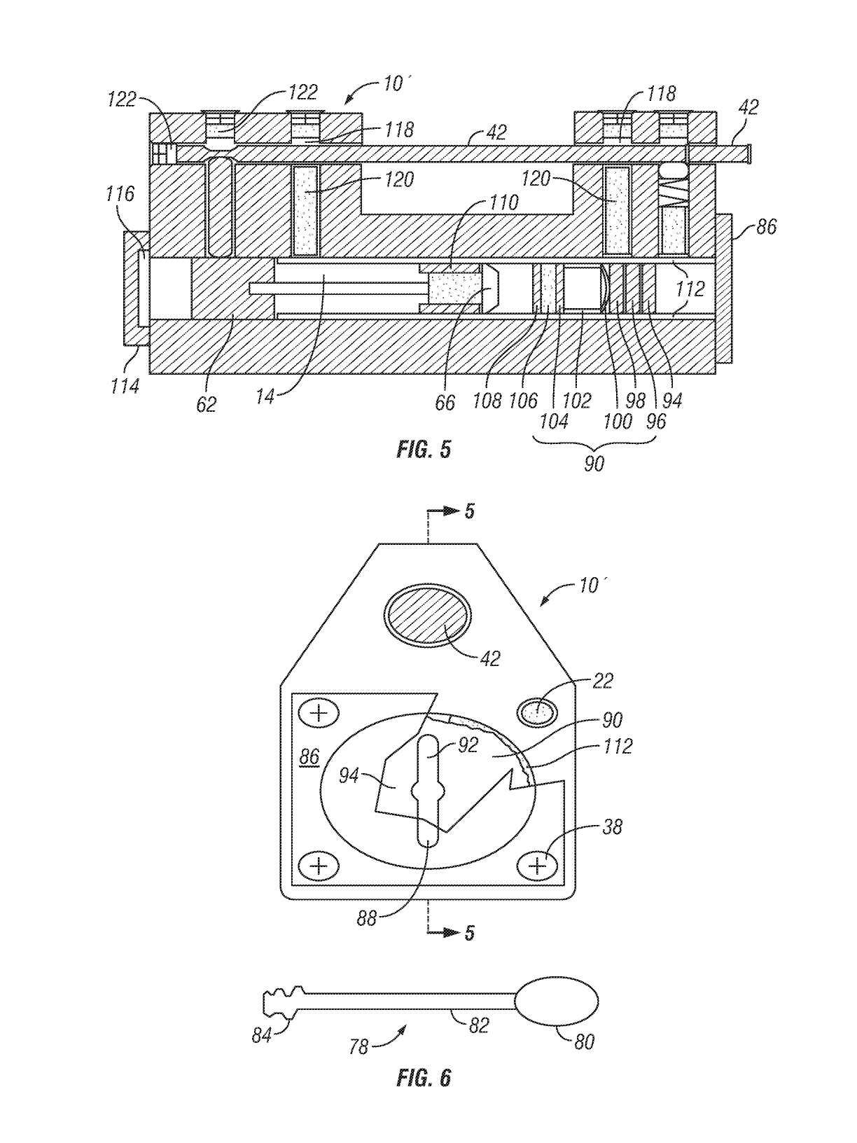

A deluxe version of the trailer lock is illustrated in FIGS. 5 and 6 as 10′. The deluxe trailer lock 10′ is provided with additional security enhancements to further foil efforts to tamper with or defeat the lock 10′. This version is shown in cross section (similar to that of FIG. 3) in FIG. 5 and with a partially cut-away end view in FIG. 6.

The deluxe embodiment 10′ utilizes a special extended key 78 which works in conjunction with the structures contained within the center bore 14. The extended key 78 is shown to include a handle 80, an elongated shaft 82, and an engaging section 84 shaped to mate with the lock cylinder 66. The deluxe version 10′ is provided with a hardened metal end plate 86 which is secured to the lock body 12 by the drive screws 38 which close the ends of the corner bores 18 (see FIGS. 1 and 2). The end plate 86 is provided with a shaped key aperture 88 to receive the extended key 78.

Situated within the center bore 14, and preferably set interior by a distance greater than the extent of the engaging section 84 of the key 78 is a cylinder guard plug assembly 90. The cylinder guard 90 is a series of components, each including a shaped key passage 92. Although the key passage 92 of the cylinder guard 90 is shown in FIG. 6 as being aligned with the key aperture 88 of the end plate 86 it may be desirable to offset the rotation of the key passage 92 such that it is necessary to turn the extended key 78 inside the center bore 14 such that the engaging section 84 is aligned with the key passage 92 in order to pass therethrough. This requires special manipulation of the extended key 78 to allow it to reach the lock cylinder 66 and can help to frustrate lock pick and skeleton key attacks.

The cylinder guard 90 is shown to be constructed in layers of wafers or disks adhered together and is described in more detail in the inventor's contemporaneous Tamper Resistant Bicycle Lock patent application (incorporated by reference herein). The various disks are formed with materials having different properties adapted to defeat different sorts of attacks. In the embodiment shown, from the outside in, the cylinder guard 90 has an exterior stainless steel disk 94 to resist breakage and drilling, a first ceramic disk 96 which is particularly effective against diamond cutting, drilling and sawing and also provides thermal and electrical insulation, and a first soft metal dusk 98, preferably formed of aluminum or another metal which will foul and bind drill bits. A reaction spring 100, preferably a Belleville washer, provides a reactive elastic member to foil hammer drills and the like which use vibrational attacks to attempt to shatter the components. A spacer tube 102 provides another elongated zone within which the extended key 78 can again be rotated to create yet another offset to enter the next section of the key passage 92. Beyond the spacer tube 102 is a second soft metal disk 104, a second ceramic disk (wafer) 106, and a terminal hard metal disk 108, preferably tool steel to provide structural integrity and breakage resistance to the cylinder guard 90. Since the cylinder guard 90 is also preferably laterally displaced from the lock cylinder 66, yet another zone for key rotation is provided. In the deluxe embodiment 10′ the user may actually have to rotationally manipulate the extended key 78 up to four times in order to successfully engage the lock cylinder 66.

Other enhancements in the deluxe embodiment 10′ include a cylinder jacket 110 of hardened metal, such as stainless steel, surrounding at least the lock cylinder 66 and potentially also extending to the end of the center bore 14, and a ceramic sheath 112 which circumferentially lines the center bore 14 to help defeat side attacks by cutting or drilling. A second end plate 114 with a ceramic plate liner 116 directly interior therefrom closes the cam end of the center bore 14.

A common method of attacking locks of the shape and nature of the trailer lock 10′ is to saw off the entry post 30 and the capture post 32, thus releasing the entire lock pin 42 portion. In order to defeat attacks of this nature the deluxe embodiment 10′ is provided with a pair of vertical barrier bores 118, each populated with a ceramic barrier plug 120 to defeat lateral sawing and cutting attacks.

Each of the vertical bores of the deluxe embodiments, as well as the pin bore 16 at the cam end, is sealed by hard metallic drive screws 38 or similar closure structures. Short ceramic plugs 122 are secured inside the bores to again provide a ceramic layer to enhance the barriers provided by the metals.

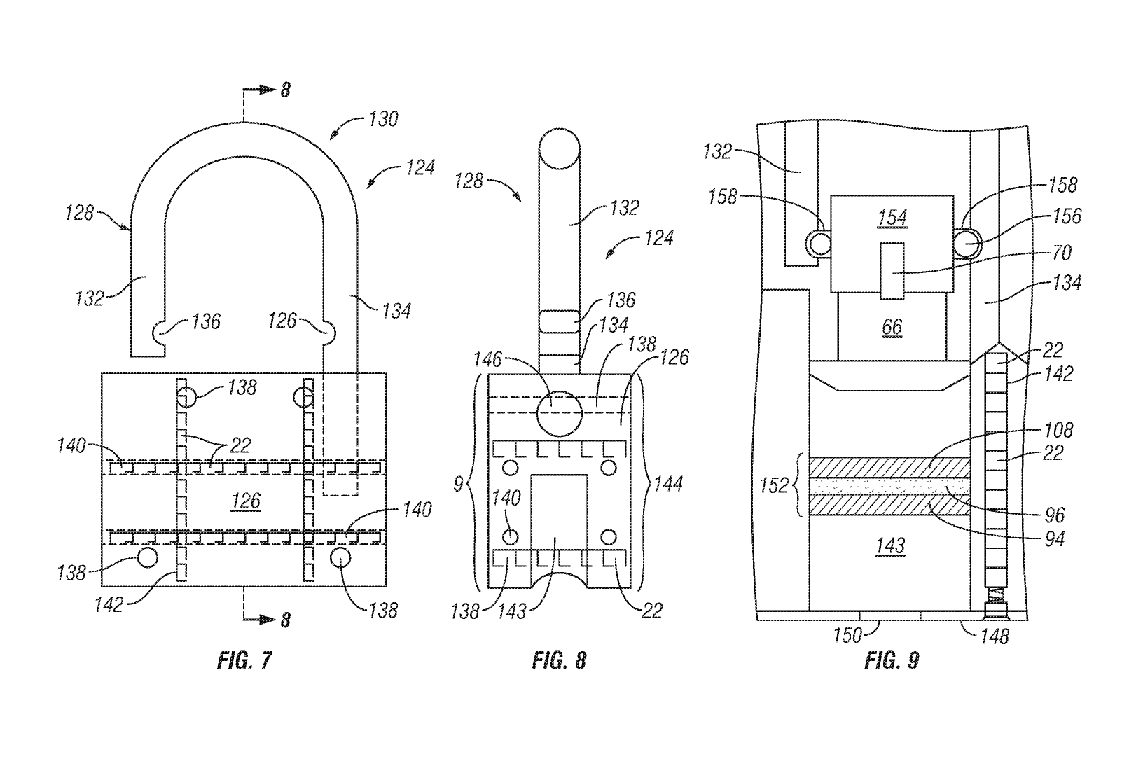

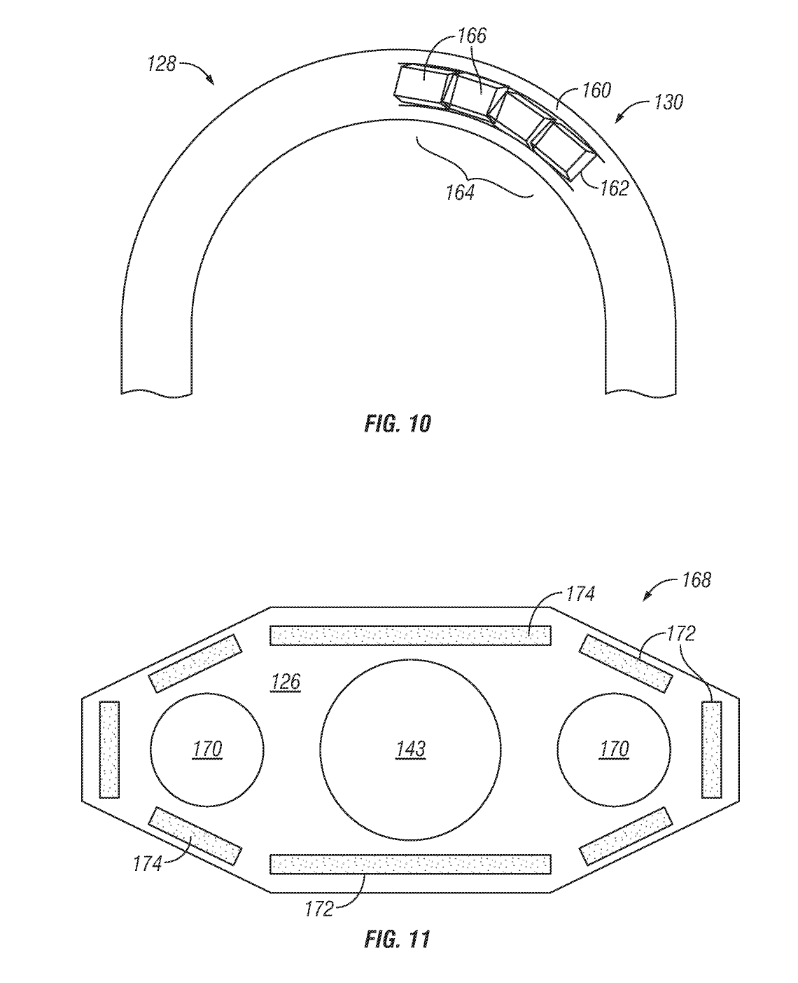

Referring now to FIGS. 7, 8, and 9, a more conventional padlock 124 is illustrated in varying views. FIG. 7 is a front elevational view with certain interior elements shown in phantom. FIG. 8 shows the same padlock 124 in a cross-sectional view, also having phantom elements. The operational interior lock components are illustrated in the detail view of FIG. 9. The various elements are described herein in connection with each of the three figures.

The padlock 124 is shown to have a metallic base 126 which is a generally solid block lock body. A shackle 128 is adapted to mate with the base 126 to enclose therebetween some element to be locked in place.

The shackle 128 is shown to have a central arc section 130 bordered by a short bar portion 132 on one end and a long bar portion 134 on the other. Each of the short bar 132 and the long bar 134 includes an interior facing shackle detent 136.

The base 126 is provided with a selection of specially placed transverse bores including longitudinal bores 138, lateral bores 140 and vertical bores 142. Each of these bores is adapted to receive ceramic elements, usually in the form of ceramic plug segments 22 to provide intermittent ceramic layers adapted to defeat cutting and drilling attacks on the functional components situated within a central bore 143. These functional components include a cylinder structure 144 and an engagement structure 146 which are not detailed in FIG. 8 but are shown in the cut-away detail view of FIG. 9.

The padlock 124 is provided with a hard metallic bottom plate 148 with a transverse keyhole 150. Situated in the interior of the central bore 143 (at a distance offset as described above with respect to FIG. 5) is an alternate cylinder guard 152. The alternate cylinder guard 152 includes only three disks; a stainless steel disk 94, a first ceramic disk 96 and a terminal hard metal disk 108. The limited size and construction of the alternate cylinder guard 152 is primarily due to space constraints but provides at least a portion of the protection of the more elaborate cylinder guard 90.

In addition to the conventional lock cylinder 66 and the connection extension 70, the engagement structure includes a double sided cam 154 having two flattened arcs 72. At least a pair of opposed padlock ball bearings 156 are situated circumferentially exterior to the double sided cam 154 and may be contained in ball bearing tubes 160 to prevent escape. In the illustration of FIG. 9 the double sided cam 154 is shown in the engaged position, with the full arc 74 portions engaging the ball bearings 156 in such a manner that the ball bearings 156 are forced laterally outward to engage both shackle detents 136 and prevent the shackle 128 from sliding and the padlock 124 from being vertically forced open. When the double sided cam 156 is rotated by the cylinder such that both flattened arcs are aligned with the padlock ball bearings 156 those ball bearings 156 can retreat inward from the shackle detents 136 such that the shackle 128 can slide upward and release the item.

The illustration of Fig. shows the arc portion 130 of a deluxe shackle 128 in a partially cut-away view. The shackle 128 includes an arc portion 130 which is shown to be curved. This embodiment 128 is provided to show that padlock shackles and the like according to the present invention are not limited to linear constructions. This structure is described in more detail in the inventor's companion application for a Tamper Resistant Bicycle Lock.

The arc portion 130 is formed of a bent metal tube 160 with a hollow center 162. A curved array 164 of discreet ceramic fish-spline links 166 (also known as “fish” 166) is contained within the hollow center 162. The fish 166 are hollow cylindrical links tapered to have a convex end and a concave end and are placed in the curved array 164 such that a convex end of one fish 166 will mesh with a concave end of an adjacent fish. The fish 166 are preferably inserted into the hollow center 162 prior to bending the metal tube 160 into the arc. The intermeshing of the fish 166 allows bending without breakage. This type of ceramic layer maintains the protocol of an outermost layer of a hard metallic material and an interior ceramic layer to provide multiple deterrents to breakage, cutting and other methods of tampering.

The illustration of FIG. 11 is a top (or bottom) view of a hex-style padlock 168 having a different shape from those previously described. The body of the hex padlock 168 includes, in addition to the central bore 143, a pair of opposed shackle bores 170. The hex lock 168 is also manufactured (preferably by extrusion or casting) to include a variety of optimally positioned longitudinal slots 172. Each of these longitudinal slots 172 is provided with a ceramic plate 174 or slab 174. These ceramic plates 174 (or slabs) form an interior ceramic layer which protects the functional elements to be contained in the center bore from drilling and cutting attacks, in accordance with the overall layering protocols of the invention.

In each of the described example embodiments to be constructed in accordance with the inventive protocol, the functions are optimized by placement of ceramic materials intermediate or within structural materials. The ceramic materials provide significantly different physical and conductive properties than the typically metallic structural materials and thus present a much different challenge to the malefactors. The outermost layer is typically hard and structurally strong, but may be subject to cutting by diamond cutters or the like. The ceramic layer, while it may be subject to breaking or crushing, is extremely resistant to physical cutting, laser cutting, and thermal attacks. This juxtapositioning of divergent materials allows the core 14 or 143 to be protected from all but the most determined and multi-pronged attacks.

As discussed above, the structural materials typically selected for the outermost layers will be metallic, and may include, steel, stainless steel, wrought iron, aluminum, brass or any other material having significant structural strength and hardness.

Ceramic materials utilized in the ceramic layer, whether continuous or intermittent, may include: alumina; zirconium; titanium diboride, graphene, transparent aluminum and zirconia toughened alumina (zta). These materials can be cast, milled, extruded or otherwise formed into any desired shape.

Dimensions and shapes of the security structures are entirely dependent on the particular application and can vary widely. In particular, lock bodies may come in different shapes and tubular structures can be in any form of hollow shape, including cross-sections in the form of ovals, non-square rectangles and other geometric configurations.

Many modifications to the above embodiments may be made without altering the nature of the invention. The dimensions and shapes of the components and the construction materials may be modified for particular circumstances.

While various embodiments have been described above, it should be understood that they have been presented by way of example only, and not as limitations.

### INDUSTRIAL APPLICABILITY

The method and protocol for constructing them and the embodiments of mechanical padlocks and padlock-like structures of the present invention is intended for use in any sort of circumstances where burglary, theft and other forms of trespass are feared. These are especially suited for construction of locking structures having shackles and lock pins such as padlocks, door and gate locks, trailer locks, and utility meter locks.

The use of the protocol involving ceramic layers in or layered inside of structural layers results in requiring malefactors to invoke multi-pronged methods of attack in order to breach or defeat the security structure. In many cases, this will defeat the typical attempt and will, at the very least, require a great deal more time and effort on the part of the perpetrators. This may have the beneficial effect of causing the selection of easier targets. All of these factors result in greater protections of persons and property than are possible with security structures according to prior art methods and protocols.

Greater effectiveness in security is the cause of significant economic advantage. In addition, construction techniques utilizing intermittent layering or modular discreet longitudinal ceramic components can lessen material costs and/or simplify assembly.

For the above, and other, reasons, it is expected that the padlock and padlock like structures according to the inventive method and protocol for constructing mechanical security structures according to the present invention will have widespread industrial applicability. Therefore, it is expected that the commercial utility of the present invention will be extensive and long lasting.

What is claimed is:

1. A tamper resistant padlock structure comprising:
a lock body formed of hard and strong structural material and enclosing a lock cylinder subsystem therewithin, said lock cylinder subsystem being contained in a central bore;
a lock shackle/pin for mating with said lock cylinder subsystem; wherein
said lock body is provided with at least one interior ceramic layer to shield said lock cylinder from attacks by thieves' tools; and
a cylinder guard is provided in said central bore exterior to said lock cylinder subsystem.

2. The tamper resistant padlock structure of claim 1 wherein
said lock body is provided with a plurality of shafts, at least some of said shafts being filled with ceramic materials.

3. The tamper resistant padlock structure of claim 1 wherein
said lock shackle/pin includes a hollow interior with ceramic segments disposed therein.

4. The tamper resistant padlock structure of claim 3 wherein
said ceramic segments are hollow and a flexible cut-resistant cable passes longitudinally therethrough.

5. The tamper resistant padlock structure of claim 1 wherein:
said cylinder guard includes alternating layers of metallic wafers and ceramic wafers.

6. The tamper resistant padlock structure of claim 1 wherein
said interior ceramic layer is comprised of materials selected from the group including: zirconium; alumina; corundum infused alumina; corundum infused zirconia; titanium diboride; graphene; transparent aluminum; and
zirconia toughened alumina (zta).

7. A trailer lock comprising
a lock body having a rectangular lower extent with wounded corners and with an entry post and a capture post extending upward therefrom with a gap therebetween, with a center bore extending longitudinally through said lower extent and a pin bore extending longitudinally through each of said entry post and said capture post; and
an elongated lock pin adapted to fit within said pin bore, said lock pin having a detent; wherein
a lock cylinder and a lock cam are aligned with said center bore, said lock cam being rotationally adapted to cause a lock engagement structure disposed within said capture post to engage said lock pin detent within said pin bore so as to secure said lock pin in a locked position.
said lock body further includes corner bores extending therethrough generally surrounding said center bore, and ceramic segments are disposed within each said corner bore.

8. The trailer lock of claim 7 wherein
said ceramic segments are ceramic plugs.

9. The trailer lock of claim 7 wherein
said ceramic segments are ceramic tube links with a capillary tube extending therethrough.

10. The trailer lock of claim 7 and further including
barrier bores extending though said entry post and said capture post toward said center bore; and
ceramic barrier plugs disposed in each said barrier bore.

11. The trailer lock of claim 7 wherein
said lock cylinder is secured within said center bore at a location inward from the end thereof, and at least one ceramic barrier is placed in said center bore between said end and said lock cylinder.

12. The trailer lock of claim and further including
metallic end plates covering the ends of said center bore.

13. The trailer lock of claim 7 wherein
said lock cylinder is secured within said center bore at a location inward from the end thereof, and a cylinder guard structure, including alternating metallic and ceramic layers protecting said lock cylinder from longitudinal attacks, is placed within said center bore between said end and said lock cylinder.

14. A tamper resistant padlock comprising:
a strong structural base having a center bore and a pair of opposed shackle bores extending therethrough;
a lock cylinder structure disposed in said center bore for activating an engagement structure;
a shackle having two opposed bars for mating with said shackle bores, each said bar having a shackle detent for interacting with said engaging structure to secure said shackle in a locked position; wherein
longitudinal, lateral, and vertical hollow bores extend within said base, strategically situated about said center bore, each said hollow bore containing ceramic segments therein to protect said center bore from attacks by thieves' tools.

15. The padlock of claim 14 wherein
said shackle further includes an arc section intermediate said opposed bars, with at least said arc section being a bent structural metal tube with fish-spline ceramic links longitudinally arrayed therein.

16. The padlock of claim 14 wherein
said lock cylinder structure is recessed within said center bore and a cylinder guard structure including alternating metallic and ceramic layers protecting said lock cylinder from longitudinal attacks is placed within said center bore exterior to said lock cylinder.

17. The padlock of claim 14 wherein
said engagement structure includes a double sided cam and ball bearings for simultaneously engaging said shackle detents of both said opposing bars.

18. The padlock of claim 14 wherein
at least some of said ceramic segments have a hollow core and contain marking fluid therewithin.
